(19) United States
(12) Patent Application Publication
(10) Pub. No.: US 2025/0041799 A1
(43) Pub. Date: Feb. 6, 2025

(54) FILTER MATERIAL AND USE THEREOF

(71) Applicants: Fabrice MENDEZ, Lattes (FR); Tünde KASZÁNÉ LANTOS, Montpellier (FR)

(72) Inventors: Fabrice MENDEZ, Lattes (FR); Tünde KASZÁNÉ LANTOS, Montpellier (FR)

(21) Appl. No.: 18/709,222

(22) PCT Filed: Nov. 10, 2022
(86) PCT No.: PCT/IB2022/060844

§ 371 Date: May 10, 2024

(30) Foreign Application Priority Data
Nov. 10, 2021 (FR) FR2111946
Dec. 27, 2021 (FR) FR2114548

(51) Int. Cl. B01D 53/82; B01D 39/06; B01D 46/30; B01D 53/72; B01J 20/10; B01J 20/28; B01J 20/30; C01B 33/32

(52) U.S. Cl. CPC B01D 53/82; B01D 39/06; B01D 46/30; B01D 53/72; B01J 20/10; B01J 20/28059; B01J 20/3078; C01B 33/32; B01D 2239/1241; B01D 2251/304; B01D 2257/7027; B01D 2258/0283; C01P 2002/82; C01P 2002/88; C01P 2006/12

(57) ABSTRACT

The invention relates to a filter containing a filter material comprising sodium silicate for filtering particles harmful to health from a gaseous medium and the use of a filter material to reduce the concentration of certain substances in a gaseous medium. More specifically, the invention relates to a filter material, use thereof and a filter containing the same, said filter material is suitable for reducing the concentration of volatile organic compounds, semi-volatile organic compounds, polyaromatic hydrocarbons, etc. in a gaseous medium.

### BACKGROUND

In some cases, the air, whether it be an open or closed environment, is contaminated with chemicals, bio-contaminants or particles and fibers that can be harmful to health. These pollutants can be of natural origin (pollens, volcanic emissions, etc.) or related to human activity (particles from industrial activities, agriculture or road transport, volatile organic compounds from building materials, etc.). In the case of indoor air, the nature of the pollutants in particular depends on the features of the building, the activities and the behavior (smoking, DIY wares, paint, etc.). In the case of outdoor air, the activities emitting pollutants, such as the industrial activities, the transport, the heating of buildings and the agriculture, also affect the chemical composition of emissions. The air quality has been a concern for years and has become a major public health problem today.

The problem of air pollution is a major environmental problem, since it affects the entire population, is a boundless, multi-pollutant and multi-source pollution type, which causes acute and chronic health effects. Additionally, it is linked to direct emissions into the atmosphere and to the complex phenomena of atmospheric chemistry and photochemistry, which allow the formation of harmful secondary substances.

### Outdoor Air Quality

The results of the Erpurs program, established by ORS Ile-de-France in 1994, in particular show that there is a relation between the pollution level and the health of the population.

The Aviation Act on Dec. 30, 1996, transposed the Community Directive 96/62/EC into the French legal system, which introduced a framework to elaborate EU laws on air quality control. This requires the Commission to submit proposals for setting regulatory limit values (average annual or even peak values) for SO2, NO2, particulate matter, O3, benzene, CO, PAHs, arsenic, cadmium, mercury and nickel. This directive was the origin of four directives setting regulatory limit values for various pollutants (directives on dangerous gases such as 99/30/EC, 2000/69/EC and 2002/3/CE, and 2004/107/EC, which determines measures for the limit values for PM2.5, PAHs, Hg and Ni).

These directives are still largely relevant today. The reference values (standards) required of Member States in relation to these European regulations are the result of work carried out by the WHO and should therefore provide a well-founded health basis.

Thereafter, the problem of dealing with alarms and peak values should be subordinated to the fight against chronic pollution every day.

### Indoor Air Quality

In contrast to the more widely publicized outdoor air pollution, the indoor air pollution remained relatively unknown until the early 2000s. We spend the majority, on average 85%, of our time in a closed environment, and most of this time we may be exposed to a number of pollutants in the closed residences, work areas, public services or vehicles.

The main indoor air pollutants are the following:
Chemical pollutants: volatile organic compounds (VOCs), nitrogen oxides (NOx), carbon monoxide (CO), polycyclic aromatic hydrocarbons (PAHs), phthalates, etc.
Bio-contaminants: mold, domestic allergens, mites, pets and cockroaches, pollens, etc.
Physical pollutants: radon, particles (artificial mineral fibers), etc.

The presence of these pollutants origins from different emission sources: building components, furniture, combustion equipments (boilers, stoves, water heaters, etc.), transmission of outdoor pollution (ambient air, contaminated soils), but it also depends on lifestyle (smoking or, for example, the presence of pets).

The air quality can affect health and well-being, and from the simple discomfort (unpleasant odours, drowsiness, eye and skin irritation) to the development or worsening of acute or chronic pathologies (respiratory diseases, respiratory allergies, respiratory distress, asthma, cancer, poisoning, etc.), thus, it is a significant health issue.

The World Health Organization (WHO) Air Quality Guidelines (updated in 2005) begin with the following findings: “Clean air is a basic requirement of human health and well-being. Air pollution, however, continues to pose a significant threat to health worldwide. [ . . . ] More than two million premature deaths each year can be attributed to the effects of urban outdoor air pollution and indoor air pollution.” In the light of this situation, WHO issues recommendations to reduce the health effects of pollution. The International Agency for Research on Cancer (IARC) of WHO classified outdoor air pollution and particle pollution as carcinogenic in 2013.

With respect to these effects, many pollutants are regulated by both French and European levels. Most of these regulations are based on WHO recommendations.

### The State of the Art

According to the above, for a long time there is an effort to eliminate or significantly reduce the effects of the combustion gases harmful for health by filtering out the combustion products or reducing their concentration.

The most commonly used solution for the removal of harmful gases is the use of HEPA filters or activated carbon. The HEPA (High Efficiency Particulate Absorbing) filter, as the name also indicates, allows the removal of the particles from the air. However, it is not suitable to filter gases, volatile organic compounds (VOCs), cigarette smoke and unpleasant odors, and in these cases it is necessary to apply an activated carbon filter in addition to or instead of HEPA filter.

The activated carbon is a carbon having a large surface area and a porous structure. Due to its high degree of microporosity, the surface area of one gram of activated carbon exceeds 500 m2. The activation level required to achieve the gas adsorption property is also available only by increasing the surface. The adsorption properties can be further improved by chemical treatment. Its production is dangerous and has high energy and cost demand, further, its regeneration is also energy and cost intensive, and the regeneration is not solved in practice. Based on literature, its gas adsorption capability is inappropriate for certain molecules.

The publication J. Phys. Chem. C, 2013, 117 (26): 13452-13461, (hereinafter NPL1) discloses that sodium metasilicate is capable of capturing CO2 gas by chemisorption at low temperature. Na2SiO3 was prepared by solid phase reaction and combustion method and their gas capturing capability was studied. In the latter process the starting materials were mixed in aqueous phase and a temperature lower than that of the solid phase process was used in the heat treatment step. The CO2 gas capturing capability is higher for Na2SiO3 made by the combustion process, but it should be noted that chemisorption requires the presence of water.

### BRIEF DESCRIPTION OF THE INVENTION

1. A filter material comprising Na₂SiO₃, characterized in that water content of the filter material is 8 to 14% by weight, preferably 10 to 14% by weight, more preferably 12 to 13% by weight, based on the total weight of the filter material.

2. The filter material according to the preceding point, characterized in that it is obtainable by the following method:
water is removed from an aqueous solution of Na₂SiO₃, the removal of water is performed at a frequency in the range of 2.0 to 3.0 GHz by microwave at a temperature of lower than 200° C.

3. The filter material according to the preceding point, characterized in that it is obtainable by the following method:
water is removed from an aqueous solution of Na₂SiO₃, the removal of water is performed at a frequency in the range of 2.45 GHz by microwave at a temperature of lower than 200° C.

4. The filter material according to point 2 or 3, characterized in that during the preparation method the removal of water is performed continuously or batchwise, and/or the material is stirred during the removal of water.

5. The filter material according to any one of the preceding points, characterized in that it is in the form of powder, granule or pellet.

6. The filter material according to any one of the preceding points, characterized in that it has characteristic peaks in its Raman spectrum at the following wavenumbers (±5 cm⁻¹): 281 cm⁻¹ and 712 cm⁻¹, preferably at the following wavenumbers (±5 cm⁻¹): 155 cm 1, 281 cm⁻¹ and 712 cm⁻¹; measured with laser having a wavelength of 532 nm.

6. The filter material according to any one of the preceding points, characterized in that its Raman spectrum preferably in the range below wavenumber of 120 cm⁻¹ does not comprise peaks having an integral value reaching the half of integral of a peak at wavenumber of 540 cm⁻¹ (±5 cm⁻¹), preferably in the range below wavenumber of 120 cm⁻¹ it does not comprise peaks.

7. The filter material according to any one of the preceding points, characterized in that its thermogravimetric (TG) curve has at least 3 decomposition steps, preferably at the following temperatures (±2° C.): 195° C., 276° C. and 293° C.; measured according to the standard MSZ EN ISO 11358-1:2014.

8. The filter material according to any one of the preceding points, characterized in that it has at most such a high peak in the range of 100 to 110° C. that corresponds to a weight loss of less than 2%, based on the initial weight of the filter material.

9. The filter material according to any one of the preceding points, characterized in that the specific surface area is at most 5 m²/g, preferably at most 1 m²/g, more preferably at most 0.5 m²/g and most preferably about 0.25 m²/g.

10. Use of a filter material comprising Na₂SiO₃ for reducing the concentration of the following substances in gaseous media, preferably in air, vapor space and/or flue gases: volatile organic compounds (VOC), semi-volatile organic compounds (SVOC), polyaromatic hydrocarbons (PAH), polychlorinated biphenyls (PCB);
or for reducing the concentration of the following substances: formaldehyde, benzene, toluene, xylenes, ethylbenzene, 1,2,4-trimethylbenzene, 1,2,3-trimethylbenzene, 1,3,5-trimethylbenzene, 2-ethyltoluene, 3-ethyltoluene, 4-ethyltoluene, n-propylbenzene, i-propylbenzene, styrene, cyclohexane, cyclopentane, n-propanol, i-propanol, n-butanol, i-butanol, diacetone alcohol, methyl acetate, ethyl acetate, n-propyl acetate, i-propyl acetate, n-butyl acetate, i-butyl acetate, acetone, methyl ethyl ketone, methyl i-butyl ketone, 2-heptanone, cyclohexanone, methyl tert-butyl ether, tetrahydrofuran, n-pentane, n-hexane, 2-hexane, n-heptane, n-octane, n-nonane, n-undecane, n-dodecane, n-tridecane, n-tetradecane, n-pentadecane, n-hexadecane, trichloroethylene, dichloromethane, tetrachloroethylene, trichloromethane, ethyl glycol, 1-methoxy-2-propanol, butyl glycol, butyl glycol acetate, ethylene glycol, propylene glycol, methanol, hydrochloric acid, sulfuric acid and sulfur trioxide, sulfur trioxide, ammonia, dioxins and dioxin-like PCBs (polycyclic chlorobenzenes)

11. The use according to point 10, wherein the filter material is the filter material according to any one of points 1 to 9.

12. The use according to point 10 or 11 for reducing concentration of PAHs.

13. A filter for filtering out particles harmful to health from a gaseous medium, comprising a filter material (9) arranged in a filter housing (1), characterized in that the filter material (9) consists of sodium silicate with a particle size in the range of 0.2 to 0.4 mm.

14. Filter according to point 13, characterized in that powdered sodium silicate is introduced as filter material (9) in the filter housing (1).

15. Filter according to point 13, characterized in that sodium silicate granules are inserted in the filter housing (1) as filter material (9).

16. Filter according to any one of points 13 to 15, characterized in that the filter material (9) is the filter material as defined in any of points 1 to 9.

17. Filter according to one of points 13 to 16, characterized in that the filter housing (1) is designed as a housing made of metal, preferably steel, with openings (6) for the flow of the gaseous medium to be filtered.

18. Filter according to point 17, characterized in that the openings (6) are formed by a metal mesh (5).

19. Filter according to one of points 13 to 18, characterized in that the filter material (9) is enclosed in a housing of gaseous fluid permeable material, forming a filter insert (8).

20. Filter according to point 19, characterized in that the housing of the filter insert (8) forms a pre-filter or post-filter layer (11, 12) with respect to the flow direction of the flowing gaseous medium.

21. Filter according to point 19 or 20, characterized in that the filter insert (8) has a shape-retaining frame (7) resulting in a filter cartridge (2).

22. Filter according to one of points 13 to 20, characterized in that the filter housing (1) itself is designed as a filter frame (2) into which the filter insert (8) can be inserted, stored and removed.

23. The filter according to one of points 13 to 22, characterized in that a support structure (10) is arranged in the filter insert (8), which ensures an even distribution of the loaded filter material (9).

24. The filter according to point 23, characterized in that the support structure (10) has a honeycomb design and the support structure (10) together with the loaded filter material (9) is closed by the cover forming the filter insert (8) in such a way as to prevent the filter material from escaping.

25. The filter according to point 23 or 24, characterized in that the support structure (10) is made of stainless steel for use in the vehicle industry.

26. The filter according to one of points 13 to 25, characterized in that one or more sensors (14) are arranged in the filter cartridge (2).

27. Filter according to point 26, characterized in that terminals of the sensor (14) are in electrical communication with respective connector surfaces (15) arranged on the filter cartridge (2).

28. The filter according to point 26 or 27, characterized in that the filter cartridge (2) has a lockable door (13) for inserting the one or more sensors (14).

### DETAILED DESCRIPTION OF THE INVENTION

The present invention relates to a filter material which is suitable for reducing the concentration of harmful reactive molecules and free radicals in a gaseous medium, preferably in air, by a combination of physical and chemical processes. The filter material according to the invention operates both mechanically and by adsorption and chemosorption, and thus it is suitable for capturing gases and vapors of substances harmful to health. Said harmful molecules are mainly formed in combustion processes, therefore, an embodiment of the invention discloses a filter material suitable for reducing the concentration of harmful reactive molecules and free radicals formed during combustion, preferably in combustion gases or flue gases. Another aspect is to chemically react with and dispose of free radicals having longer or shorter lifetimes in the flue gases. The filter material can be regenerated by hot air purge or washing with an apolar liquid. Reactivation can be performed by repeating the production process.

The invention further relates to the preparation of these filter materials and to a filter system comprising the filter material.

During our studies to solve the above problems, we have surprisingly found that solid sodium metasilicate, i.e. Na₂SiO₃, containing small amounts of water is an excellent adsorbent, which feature was not previously known. The use areas of water glass so far have been very different, such as metal repair, adhesive, drilling fluid, passive fire protection or concrete and masonry treatment.

Accordingly, the invention relates to a filter material comprising Na₂SiO₃, characterized in that the water content of the filter material is 8 to 14% by weight, preferably 10 to 14% by weight, more preferably 12 to 13% by weight, based on the total weight of the filter material. A Benetech Moisture Meter GM620 type equipment was used in SPC1 mode (M1) to determine the water content.

In one embodiment, the filter material comprising Na₂SiO₃ according to the present invention is obtained by the following production process: water is continuously removed from an aqueous solution of Na₂SiO₃ until it becomes hard foam, and then it is ground to a fine powder. Any solid Na2SiO3 can be used without limitation to prepare the aqueous solution, and there is no limitation on the concentration of the solution prepared. In a preferred case, the resulting solution has a concentration of 30-40% by weight. In one embodiment, the starting material is Na₂SiO₃ dissolved in water, which may be as well commercially available. Preferably, the removal of water is performed by microwave, preferably at a frequency of 2.0 to 3.0 GHz. The time period of removal of water depends on the weight of substance in the solution. During the removal of water, the temperature of the solution containing Na₂SiO₃, then of the suspension obtained during concentrating, and finally of the solid material is held below 200° C. If necessary, the removal of water by microwave irradiation can be performed continuously or by inserting one or more rest periods. During the rest periods, the material cools down and thus never exceeds 200° C. when the appropriate water content is reached. The removal of water is carried out until the water content reaches the above value. During microwave irradiation, the irradiated material is regularly sampled and its water content determined by methods known to those skilled in the art. If necessary, the material is stirred during the rest period(s). In the last step, the final form of the filter material is formed, which, depending on the application, preferably can be powder, granule, pellet.

The powder form is prepared by grinding, preferably to a grain size of 0.2 to 0.4 mm. The grain size is the number average grain size that can be determined by Scanning Electron Microscope (SEM). The resulting material is a snow-white powder. The granule form is an asymmetric aggregate, the shape of which is partly cylindrical and partly spherical. It has an uneven surface and a more or less porous texture. It has a size determined with a sieve is preferably 0.8 to 2.0 mm. It can be prepared by methods known to those skilled in the art, e.g. by dry granulation. The pellet form is a symmetrical aggregate having a round shape. It has a smooth, even surface, its texture is less porous than that of the granules. It has a size determined with a sieve is preferably 0.5 to 2.0 mm, more preferably 0.5 to 1.0 mm. It can be prepared by methods known to those skilled in the art, e.g. by dry granulation or oscillating granulation.

The filter material comprising Na₂SiO₃ according to the invention contains mainly Na₂SiO₃. The filter material may contain, in addition to water, one or more additional components in an amount of 0 to 1% by weight, preferably 0 to 0.2% by weight, based on the total weight of the filter material. This or these other component(s) is (are) generally the residues of the additives, and other synthesis auxiliaries of said adsorbent. The Na₂SiO₃ containing filter material according to the invention preferably consists essentially of Na₂SiO₃ (and contains adsorbed water) and further contains trace amounts of contaminants, e.g. the following metals or their ions: magnesium, calcium, potassium, aluminum, iron and manganese, which are introduced into the filter material during the preparation process.

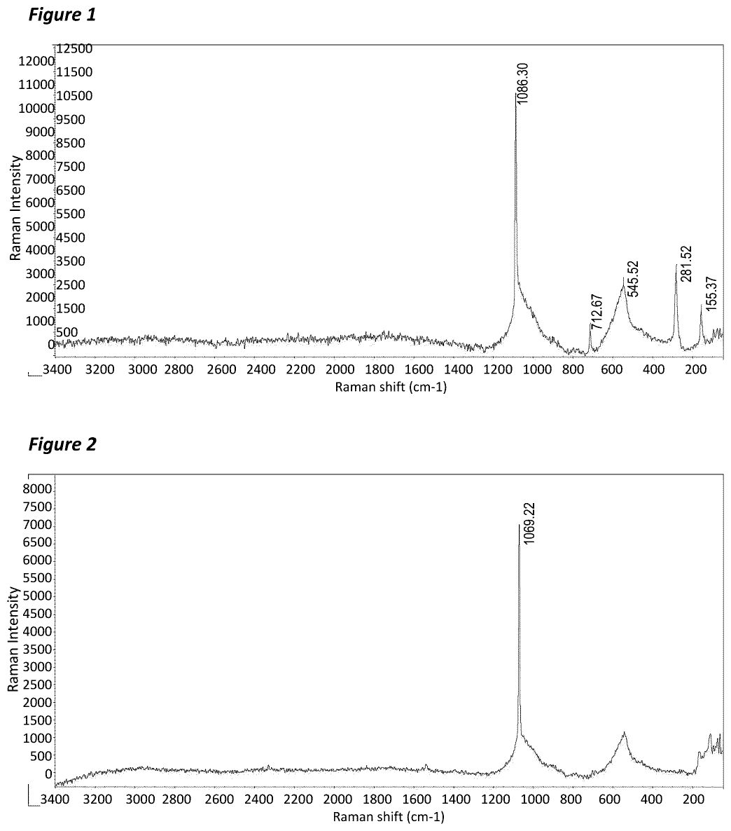

In one embodiment, the filter material comprising Na₂SiO₃ according to the invention has characteristic peaks in its Raman spectrum at the following wavenumbers (±5 cm⁻¹): 281 cm⁻¹ and 712 cm⁻¹, preferably at the following wavenumbers (±5 cm⁻¹): 155 cm⁻¹, 281 cm⁻¹ and 712 cm⁻¹. The Raman spectrum of the filter material according to the invention preferably in the range below wavenumber of 120 cm⁻¹ does not comprise peaks having integral value reaching the half of integral of a peak at wavenumber of 540 cm⁻¹ (±5 cm⁻¹), more preferably in this range it does not comprise peaks. Even more preferably, the Raman spectrum of the filter material according to the invention is substantially the same as that shown in FIG. 1. The wavelength of the laser used to record the Raman spectra is 532 nm, and the instrument is a DXR3xi Raman Imaging Microscope (ThermoFisher).

In one embodiment, the thermogravimetric (TG) curve of the filter material comprising Na₂SiO₃ according to the invention has at least 3 decomposition steps, preferably at the following temperatures (±2° C.): 195° C., 276° C. and 293° C. Preferably, the TG curve of the filter material according to the invention has at most such a high peak in the range of 100-110° C. (a peak indicating water loss) that corresponds to a weight loss of less than 2% based on the initial weight of the filter material. Even more preferably, the TG curve of the filter material according to the invention is substantially the same as that shown in FIG. 4. The thermogravimetric test was performed according to the standard MSZ EN ISO 11358-1:2014.

The specific surface area of the filter material comprising Na₂SiO₃ according to the invention can be determined by methods known by a skilled person, for example BET measurement according to ISO standard 9277:2010. The specific surface area of the filter material is at most 5 m²/g, preferably at most 1 m²/g, more preferably at most 0.5 m²/g and most preferably about 0.25 m²/g.

The adsorbent of the present invention may be in various forms, such as those well known to those skilled in the art specializing in adsorption, and for example and in a nonlimiting manner, the adsorbent of the invention may be in the form of beads, strands, extrudates, but also membranes, films and the like.

In a preferred embodiment, the filter material is placed in a housing made of gaseous fluid permeable material, e.g. in a dense metal mesh, and forms a filter insert. In such a case, it is also advantageous if the housing of the filter insert forms a pre-filter or post-filter layer with respect to the flow direction of the flowing gaseous medium. Examples of suitable pre-filter and post-filter layers are dense metal mesh, biopsy sponge, textile (e.g. G3 or G4 textile filter layer) or, e.g. in the case of use as a cigarette filter, a filter layer made of cellulose acetate fibers.

The filter material or filter insert containing Na₂SiO₃ according to the invention may contain other adsorbent materials, e.g. activated carbon, zeolites, silicates and/or plastic polymers. According to another aspect of the invention, the invention relates to a filter, i.e. a filter material arranged in a filter housing, which filter material in a preferred embodiment is Na₂SiO₃, and in a more preferred embodiment the filter material is the above filter material comprising Na₂SiO₃ according to the invention.

According to a preferred embodiment, a powdered filter material is inserted in the filter housing.

According to a further preferred embodiment, filter material granules are inserted in the filter housing.

In a preferred embodiment, the filter housing is designed as a housing made of metal, preferably steel, with openings for the flow of the gaseous medium to be filtered. In this case, it is advantageous if the walls of the filter housing are formed by a dense metal mesh.

In order to prevent the small particle size filter material from falling out of the filter housing, in a preferred embodiment the filter material is placed in a housing of gaseous fluid permeable material and forms a filter insert. In such a case, it is also advantageous if the cover of the filter insert forms a pre-filter or post-filter layer with respect to the flow direction of the flowing gaseous medium.

According to a further preferred embodiment, the filter insert has a shape-retaining frame resulting in a filter cartridge.

According to a further preferred embodiment, the filter housing itself is designed as a filter frame into which the filter insert can be inserted, stored and removed.

According to a further preferred embodiment, a support structure is arranged in the filter cartridge to ensure an even distribution of the loaded filter material. According to a preferred embodiment, this support structure has a honeycomb-like design, which, together with the loaded filter material, is closed by the cover forming the filter insert in such a way as to prevent the filter material from escaping.

The material of the support structure may depend on the field of use, for example in case of use in the vehicle industry it may be made of stainless steel.

According to a preferred embodiment, one or more sensors are arranged in the filter cartridge, for the insertion of which preferably a lockable door is formed on the filter cartridge. According to a further preferred embodiment, the terminals of the one or more sensors are in electrical communication with respective connector surfaces arranged on the filter cartridge.

The filter can be considered to be universal, as its construction and unrestricted geometry allow a filter having specific production parameters to be cut to size and integrated into a target system.

The filter will now be described in more detail, by way of example, with reference to the accompanying drawings, in which

FIG. 10 shows a perspective view of a possible embodiment of the filter according to the invention,

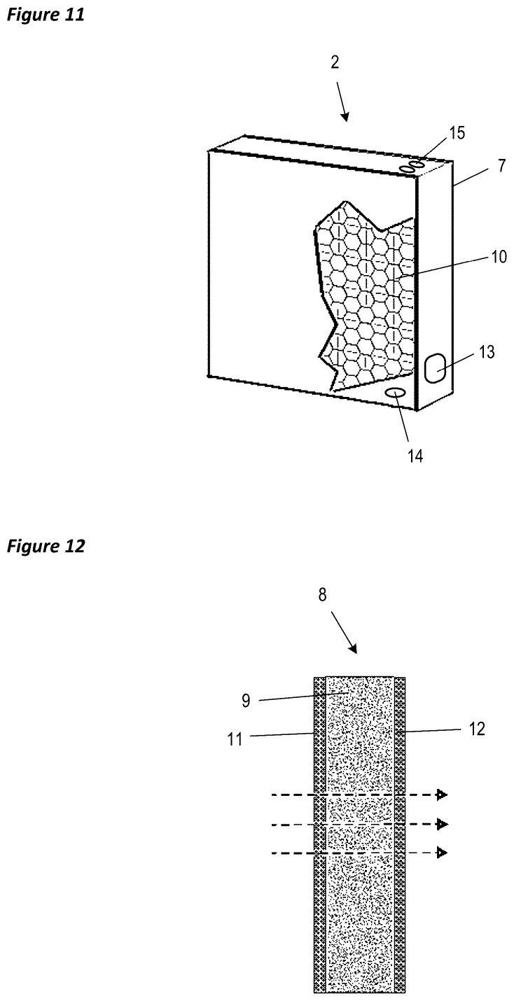

FIG. 11 shows a filter cartridge which can be placed in the filter housing of a possible embodiment of the filter according to the invention, partly cut out,

FIG. 12 shows a detail of a cross-section of a possible filter cartridge that can be used in the filter according to the invention.

The embodiment of the proposed filter shown in the Figures comprises a filter cartridge 2 arranged in a filter housing 1. In the example shown, the filter housing 1 is made of stainless steel, but can be made of other suitable materials, such as plastic, but also wood or even cardboard. An opening 3 is formed in the filter housing 1 through which the filter cartridge 2 can be inserted into the filter housing 1. In the present example, the opening 3 can be closed with a door 4 in the operating state of the filter, but the door 4 can be omitted if the filter cartridge 2 sufficiently fills the interior of the filter housing 1 so that the gaseous medium to be filtered, in this example air, can not bypass the filter cartridge 2, which could even make filtering ineffective. In the present example, side walls of the filter housing 1 extending perpendicular to the air flow are formed by a dense metal mesh 5, but any one or more openings 6 can be formed in the side walls to allow the air stream to be filtered through the filter without a significant pressure drop.

The cut-out in FIG. 11 shows an exemplary structure of the filter cartridge 2. The filter cartridge 2 comprises a frame 7 which surrounds a filter insert 8. The function of the frame 7 is to hold the layers of material used for filtration and, of course, the filter material 9 together and to provide necessary mechanical strength. In the filter insert 8, according to the example, a honeycomb-like support structure 10 is arranged, which ensures an even distribution of the loaded filter material 9, in this example granules. Such a support structure 10 is most needed in the case of a filter material 9 in powder or fine-grained granular state, and in the case of larger-grained and sufficient granules, an even distribution of the filter material 9 can be considered to be ensured.

Two outer delimiting surfaces of the filter insert 8 are formed by pre-filtration and post-filtration layers 11, 12, which in the present example are made of stainless steel, but a HEPA filter can also be used. In the exemplary filter, the thickness of the filter material 9 in the filter insert 8 is 20 mm and the thickness of the layers 11, 12 is 5 mm, which has been shown by experiments to provide the targeted filtration efficiency without considerable pressure drop. Of course, the application, number and arrangement of the layers 11, 12 can be implemented differently according to the respective task.

In the example shown, the filter insert 8 of moderate mechanical strength is inserted into a filter cartridge 2 which provides the required mechanical strength and easy handling. This solution makes it possible to insert 8 filter cartridges with the appropriate parameters into a filter cartridge 2 quickly and easily. Of course, the filter according to the utility model can also be designed in such a way that the filter insert 8 itself acts as a filter cartridge 2 and the filter insert 8 can be inserted into the filter housing 1 on its own.

It will be apparent to those skilled in the art that structural elements not shown in the drawing can be mounted or formed on the filter housing 1, by means of which the filter can be connected to other components, such as ventilation ducts, vehicle cleaning systems, etc., according to the particular application.

In order to monitor the efficiency of the filtration or other values related to the filtration during use, one or more sensors, such as an air quality detection module ZP07-MP503, may also be included in the filter cartridge 2 either during manufacture or can be inserted later during assembly for use. In FIG. 11, a door 13 is used for this purpose, through which a selected sensor 14, shown only symbolically in the Figure, can be inserted and fixed. In the present example, the sensor 14 has two terminals which communicate with connector surfaces 15 formed on the wall of the filter cartridge 2. These are preferably formed in the vicinity of the sensor 14, which is shown at the top of the filter cartridge 2 in FIG. 11 for illustration only. In this case, contacts not shown in the drawing are arranged in the filter housing 1 being in connection with the connector surfaces 15 of the inserted filter cartridge 2 in any manner known in the art, for example via springs of electrically conductive material, and an electronics receiving and processing the monitored parameter is connected to the sensor 14 via these contacts. The number of the connector surfaces 15 and the contacts operatively connected to them depends, respectively, on the respective sensor 14 and the number of sensors 14, respectively. Installing in the filter cartridge 2 one or more sensors 14 with own energy source and own wireless communication unit, the lifetime of which is in line with the usability and lifetime of the filter cartridge 8, is also possible. In this case, no connector surfaces or spring contacts are required.

### LIST OF USED REFERENCE SIGNS

1 filter housing
2 filter cartridge
3 opening
4 door
5 metal mesh
6 opening
7 frames
8 filter insert
9 filter media
10 support structure
11, 12 layer
13 door
14 sensor
15 connector surface

According to another aspect of the invention, the invention relates to the use of the above filter material for reducing the concentration of the following substances in gaseous media, preferably in air, vapor space and/or flue gases: e.g. volatile organic compounds (VOC), semi-volatile organic compounds (SVOC), polyaromatic hydrocarbons (PAH), polychlorinated biphenyls (PCB); or, e.g. for reducing the concentration of the following substances in gaseous media, preferably in air, vapor space and/or flue gases: formaldehyde, benzene, xylenes, ethylbenzene, 1,2,4-trimethylbenzene, 1,2,3-trimethylbenzene, 1,3,5-trimethylbenzene, 2-ethyltoluene, 3-ethyltoluene, 4-ethyltoluene, n-propylbenzene, i-propylbenzene, styrene, cyclohexane, cyclopentane, n-propanol, i-propanol, n-butanol, i-butanol, diacetone alcohol, methyl acetate, ethyl acetate, n-propyl acetate, i-propyl acetate, n-butyl acetate, i-butyl acetate, acetone, methyl ethyl ketone, methyl i-butyl ketone, 2-heptanone, cyclohexanone, methyl tert-butyl ether, tetrahydrofuran, n-pentane, n-hexane, 2-hexane, n-heptane, n-octane, n-nonane, n-undecane, n-dodecane, n-tridecane, n-tetradecane, n-pentadecane, n-hexadecane, trichloroethylene, dichloromethane, tetrachloroethylene, trichloromethane, ethyl glycol, 1-methoxy-2-propanol, butyl glycol, butyl glycol acetate, ethylene glycol, propylene glycol, methanol, hydrochloric acid, sulfuric acid and sulfur trioxide, sulfur trioxide, ammonia, dioxins and dioxin-like PCBs (polycyclic chlorobenzenes).

The term reduction of concentration is preferably understood to mean the filtration, i.e. the gaseous medium containing the given substance is passed through the space containing the filter material during the application.

### EXAMPLES

### Example 1—Preparation Method

The water is continuously removed from liquid water glass (Product name: DIY Onyx Sodium silicate, product code: C29050106, dry matter: about 35.8%, pH in aqueous solution: about 12.5, density: 1.372+/−0.015, viscosity: 625 mPa·s at 20° C.) until it becomes a hard foam, and then it is ground to a fine powder. The removal of water is performed in a microwave generator at a frequency of 2.45 GHz. We have observed that not only the thermal effect plays a role in the use of the microwaves, but also physical and chemical change occurs in the material. It modifies the properties of the material, as shown by our measurements. We found in our measurements that the material quality of the material produced by the microwave is different and its absorption capability is higher than that of the material produced in an electric oven at the same parameters (Examples 5-8). The duration of irradiation per 200 g of liquid starting material is a total of 12 minutes, which consists of three equally divided phases. A rest of 1 minute follows after the first 4 minutes, at this time the temperature of material is 108.2° C. After the subsequent irradiation of 4 minutes, again a rest of 1 minute is performed, where the temperature is 133° C. At this time the material is stirred extensively. This is followed by the finalizing last 4-minute phase. It is important that the material does not exceed 200° C. during the last irradiation either. A Benetech Moisture Meter GM620 type equipment was used in SPC1 mode (M1) to determine the water content. The material obtained in the process has a water content of 12% by weight. The specific surface area of the obtained material is 0.25 m²/g, measured according to ISO 9277:2010. A grain size of 0.2 to 0.4 mm is formed during grinding. The material thus obtained is a snow-white powder having an amorphous structure (Example 9).

### Example 2—Efficacy

A filter insert was formed from the filter material of Example 1 with using G3 filter material as a housing (properties: polypropylene material, thickness: 16 mm, gravimetric separation degree: 82%, filter class: G3, pressure drop at 1.5 m/s: 22 Pa, maximum pressure drop: 250 Pa). A PAH source was an oven connected to the filter insert in a closed system. This was attached to a gas washing bottle filled with hexane (200 ml). The whole system was connected to a water jet pump that provided the necessary suction power. During the study it was observed that there was no visible flue gas in the gas washing bottle when using the filter, and no odor was detected. In the case of no filtration, the flue gas in the gas washing bottle became an opaque, non-translucent brown color, whereas when using the filter, a perfectly clear transparent colorless flue gas was obtained.

The gas washing bottle contained 15 ml of n-hexane, which was transferred to a test tube at the end of the measurement and evaporated to 1.5 ml under a stream of nitrogen. The obtained sample containing hexane was analyzed by gas chromatography, where the limit of detection (nd) of the applied method was 0.0005 μg per component.
MS000: Blank sample (hexane blank, without gas passing);
MS001: Atmospheric air (air passing through hexane without filter);
MS002: Active PAH source (flue gas passing through hexane without filter);
MS003: PAH source according to MS002 with 0.3 g of filter material;
MS004: Active intense PAH source;
MS005: PAH source according to MS004 with 30.0 g of filter material.

TABLE 1

| | MS 000 | | | | | |
|---|---|---|---|---|---|---|
| | Blank / | MS 001 / | MS 002 / | MS 003 / | MS 004 / | MS 005 / |
| Components | μg | μg | μg | μg | μg | μg |
| naphthalene | nd | nd | 0.304 | 0.305 | 42.9 | 2.91 |
| 2-methyl-naphthalene | nd | nd | 0.067 | nd | 1.29 | nd |
| 1-methyl-naphthalene | nd | nd | 0.097 | 0.012 | 1.07 | 0.003 |
| acenaphthylene | nd | nd | 0.039 | 0.002 | 2.79 | 0.052 |
| acenaphthene | nd | nd | 0.014 | nd | 0.026 | nd |
| fluorene | nd | nd | nd | nd | 0.233 | nd |
| phenanthrene | nd | nd | nd | nd | 0.753 | nd |
| anthracene | nd | nd | 0.009 | nd | 0.224 | nd |
| fluoranthene | nd | nd | nd | nd | 0.631 | nd |
| pyrene | nd | nd | nd | nd | 0.574 | nd |
| benz(a)anthracene | nd | 0.001 | 0.004 | 0.001 | 0.229 | nd |
| chrysene | nd | nd | 0.002 | nd | 0.158 | nd |
| benzo(b)fluoranthene+ | nd | 0.019 | 0.015 | 0.037 | 0.393 | 0.023 |
| benzo(k)fluoranthene | | | | | | |
| benzo(e)pyrene | nd | 0.002 | 0.001 | 0.001 | 0.147 | nd |
| benzo(a)pyrene | nd | 0.002 | 0.002 | nd | 0.25 | nd |
| indeno(1,2,3-cd)pyrene | nd | nd | 0.001 | nd | 0.222 | nd |
| dibenzo(a,h)anthracene | nd | 0.002 | nd | nd | 0.028 | nd |
| benzo(g,h,i)perylene | nd | 0.004 | nd | nd | 0.211 | nd |
| Total naphthalenes | nd | nd | 0.468 | 0.317 | 45.3 | 2.91 |
| Total PAH without | nd | 0.03 | 0.087 | 0.041 | 6.87 | 0.075 |
| naphthalenes | | | | | | |
| Total PAH | nd | 0.03 | 0.555 | 0.358 | 52.2 | 2.99 |

As can be seen from the comparison of data sets MS002-MS003, even 0.3 g of filter material is capable to filter out 35.5% of PAHs. The comparison of data sets MS004-MS005 makes it clear that 30 g of filter material filters out 94% of PAHs from the flue gas.

### Example 4—Preparation Method of the NPL1 Product

The NPL1 product was prepared by the combustion method described in said article. The sample was prepared by the combustion method using sodium hydroxide (NaOH, Aldrich), SiO₂, and urea (CO(NH₂)₂, Aldrich). NaOH and urea were dissolved in the minimum water quantity, and then SiO₂ was dispersed in this solution, obtaining a viscous material, which was heated at 70° C. until dried. Finally, the powder was heat-treated at 500° C. for 5 min and then at 700° C. for 4 h in order to crystallize the material.

### Example 5—Raman Comparison

The silicates prepared according to Examples 1 and 4 were studied with the available Raman microscope, which is one of the most modern techniques, with a resolution of up to 1-5 μm. The device was a DXR3xi Raman Imaging Microscope (ThermoFisher). The laser used had a wavelength of 532 nm.

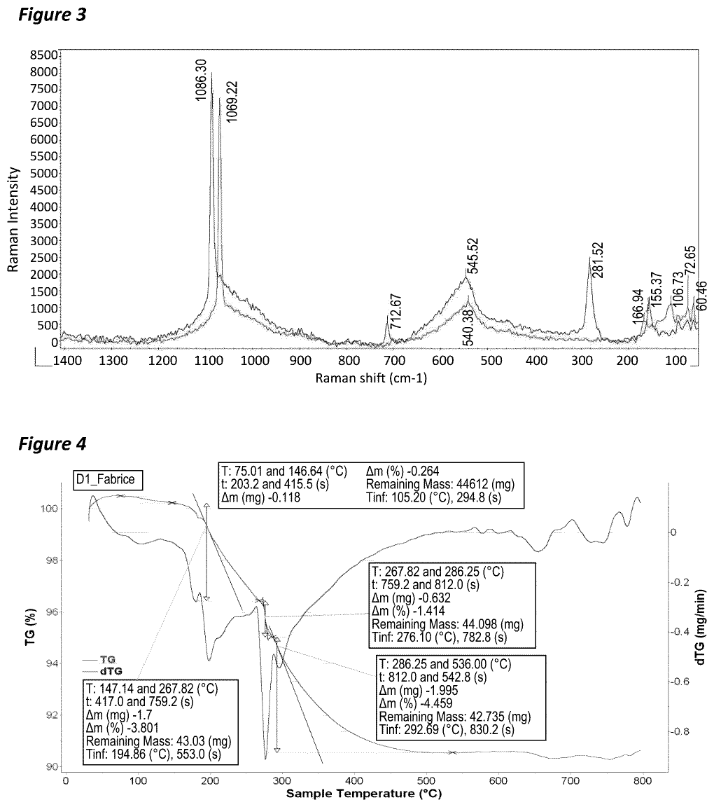

FIGS. 1 and 2 show the individual Raman spectra over the entire range (50 to 3400 cm⁻¹) recorded from the samples. Tables 2 and 3 show the intensities belonging to the peaks. FIG. 3 compares the spectra of the samples. There is a significant difference in the Raman spectrum of the samples: peaks can be observed at wavenumbers of 281.5 and 712.7 cm⁻¹ in the spectrum of the sample according to the invention, in the case of the NPL1 sample no peaks were observed at these places. The peak with the highest intensity is at wavenumber of 1086.3 in the sample according to the invention; and for the NPL1 sample at 1069.2 cm⁻¹. This is a clear indication that the two samples are partly different even in terms of material quality.

TABLE 2

| The position | |
|---|---|
| of the peaks | |
| in the sample | Relative |
| according to the | intensity of |
| invention/cm⁻¹ | the peaks |
| 155.37 | 1373.121 |
| 281.52 | 3069.677 |
| 545.52 | 2452.104 |
| 712.67 | 510.722 |
| 1086.3 | 11045.308 |

TABLE 3

| The position of | Relative |
|---|---|
| the peaks in the | intensity of |
| NPL1 sample/cm⁻¹ | the peaks |
| 60.46 | 1113.154 |
| 72.65 | 978.019 |
| 94.09 | 761.232 |
| 108.73 | 1098.92 |
| 165.94 | 574.484 |
| 540.38 | 1162.581 |
| 1069.22 | 7275.068 |

### Example 6—Thermogravimetric (TG) Comparison

TG test was performed in accordance with th standard MSZ EN ISO 11358-1:2014.

The measurements were performed with a Setaram, Labsys Evo TGA meter. A nitrogen atmosphere as an inert medium, a temperature range of 50 to 800° C. and a heating rate of 20° C./min were used during the measurement. In the instrument the sample is placed on a high-sensitivity analytical balance, which is in an electrically and programmed heated oven. Thus, the instrument records the Δm curve as a function of temperature. Many physical changes and phase transitions can be characterized in this way by the instrument. The derivative of the curves (dTG) is also shown in the figures in order to get a more accurate and detailed analysis.

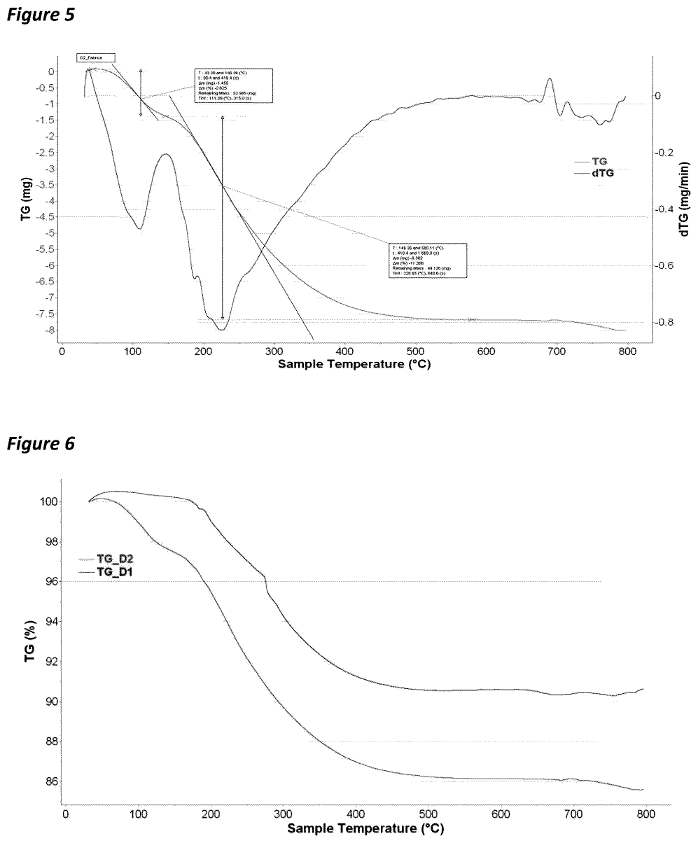

The results of the TGA analysis of the samples are summarized in Table 4. 4 decomposition steps can be distinguished in the case of the sample according to the invention and 2 decomposition steps in the case of the NPL1 sample. The first of these steps may indicate the water loss. The total weight loss at 800° C. in the case of the sample according to the invention is 9.7%; and 14% in the case of NPL1 sample. FIGS. 4 and 5 show the weight loss (TG) and its derivative (dTG) of the two samples as a function of temperature, and the relative TG curves of the two samples can be compared on FIG. 6.

TABLE 4

| | |
|---|---|
| T_{inf} [° C.] | Weight loss [%] |

| | Product | | Product | |
|---|---|---|---|---|
| Decomposition | of the | | of the | |
| steps | invention | NPL1 | invention | NPL1 |
| 1 | 105.2 | 111.1 | 0.26 | 2.6 |
| 2 | 194.9 | 226.7 | 3.8 | 11.4 |
| 3 | 276.1 | — | 1.4 | — |
| 4 | 292.7 | — | 4.5 | — |

The weight losses can be attributed to the drying and the presence of the physically bound volatiles. There was no phase transition in this range. It can be seen well that the two different samples are capable of binding different amounts of other molecules, additionally which are released in different ranges. This indicates that these bound components have different material qualities.

Furthermore, it is important to pay attention to the course of the two TGA curves shown in FIG. 6. It is clear from this that they are not only shifted relative to each other, but the shoulders on them also form different curves. This indicates that there is a difference not only in the crystalline form but also in the material quality and composition, and it is clear that the released molecules differ in their amount and bond strength, and therefore probably also in their quality.

### Example 7—ICP-OES

The mobile metal ions in the lattice can have a great effect on the interactions formed by the crystals, so we have also studied them. The used device was an Analytik Jena PlasmaQuant PQ9000 ICP-OES, Analytik Jena TopWave, which can be used for trace analysis. Our results are shown in Table 5.

TABLE 5

Samples

| | Product | |
|---|---|---|
| | of the | |
| | invention | NPL1 |
| Elements | mg/kg d.m. | mg/kg d.m. |
| Mg | 3.98 | 6.32 |
| Ca | 233 | 301 |
| Na | 29086 | 29557 |
| K | 480 | 635 |
| Al | 10.6 | 12 |
| Fe | 4.34 | 3.06 |
| Mn | 0 | 0.13 |

It can be clearly seen from the table that the content of magnesium among the listed metals differs considerably, and the potassium is also significant, but the content of each metal in the two samples shows difference. This may be due to the fact that they are capable to establish certain interactions in different extent.

### Example 8—Microscope

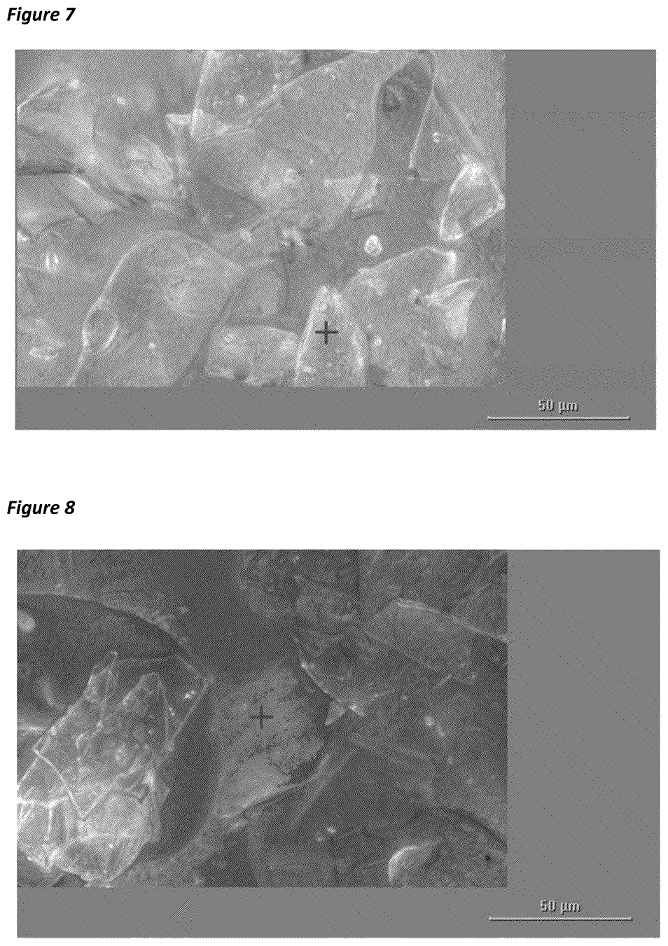

FIGS. 7 and 8 show photographs of the crystals. These prove the different lattice structure, which is clear using a resolution of 50 micrometers. The different crystal structure and morphology depend on the other production technique, and basically determine the properties, adsorption capability of the silicate minerals and their capability to retain certain molecules.

### Example 9—XRPD

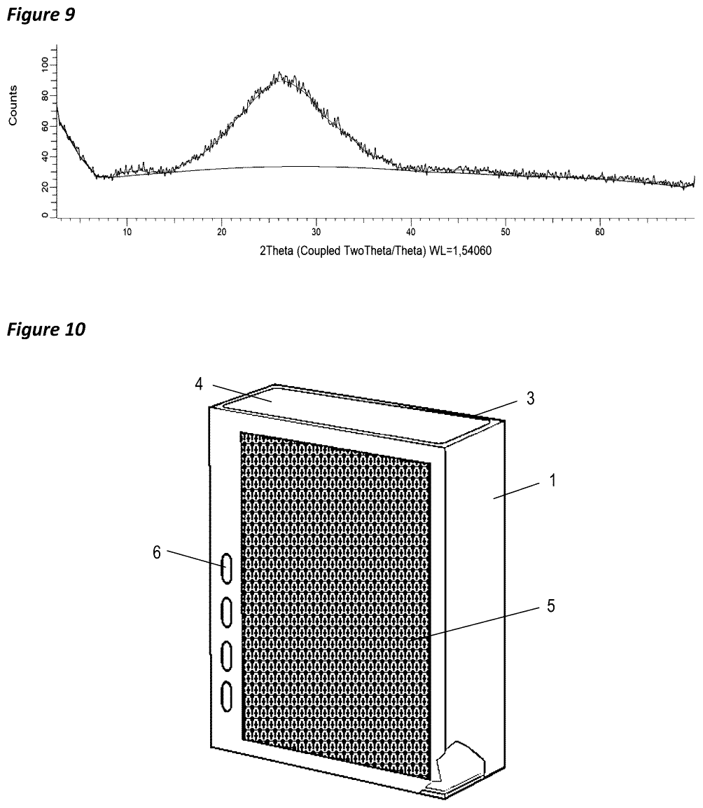

X-ray diffraction phase identification of the sample according to the invention was performed. The tests were performed with a Bruker D8 Davinci Advance instrument. The studied pieces were measured in Bragg-Brentano geometry using Cu K-alpha1-alpha2 radiation with an accelerating voltage of 40 kV and a current of 40 mA. As can be clearly seen in FIG. 9, the sample has an amorphous structure.

### Example 10—Comparison of Efficacy

3 individual samples with known exact weight were taken from both the sample according to the invention and from NPL1. The samples were placed in closed containers, which are previously filled with a volume of about 20 to 30 ml of the following solutions, and the containers were sealed:
Ammonia: nominal concentration: 25%;
Formaldehyde: Formaldehyde 36% (39 w/v %) stabilized with 10% Methanol.

Each sample was in contact with the different vapor spaces for at least 72 hours, and each sample was in contact with a vapor space containing only one component. We tried to avoid the competitive binding of different compounds in this way.

They were then packaged to reduce exposure to outside air, as much as possible, and then transported to the cooperating laboratory.

It should be noted that the samples lost their previously porous structure, became cake-like, and their original white color became light blue. These materials are miscible with water, so it can be assumed that water binding has also occurred on the surfaces.

The results are summarized in Table 6.

6. táblázat

Bound quantity [μg/g]

| Studied | Product of | |
|---|---|---|
| component | the invention | NPL1 |
| 1. Ammonia | 22 | 16 |
| 2. Formaldehyde | 231 | 215 |

The results in the table show that the samples carried ammonia and formaldehyde. In addition, it can be seen that the sample according to the invention was contaminated with more ammonia and formaldehyde per unit mass.

1. A method for reducing the concentration of the following substances in gaseous media, preferably in air, vapor space and/or flue gases: volatile organic compounds (VOC), semi-volatile organic compounds (SVOC), polyaromatic hydrocarbons (PAH), polychlorinated biphenyls (PCB);
or for reducing the concentration of the following substances: formaldehyde, benzene, toluene, xylenes, ethylbenzene, 1,2,4-trimethylbenzene, 1,2,3-trimethylbenzene, 1,3,5-trimethylbenzene, 2-ethyltoluene, 3-ethyltoluene, 4-ethyltoluene, n-propylbenzene, i-propylbenzene, styrene, cyclohexane, cyclopentane, n-propanol, i-propanol, n-butanol, i-butanol, diacetone alcohol, methyl acetate, ethyl acetate, n-propyl acetate, i-propyl acetate, n-butyl acetate, i-butyl acetate, acetone, methyl ethyl ketone, methyl i-butyl ketone, 2-heptanone, cyclohexanone, methyl tert-butyl ether, tetrahydrofuran, n-pentane, n-hexane, 2-hexane, n-heptane, n-octane, n-nonane, n-undecane, n-dodecane, n-tridecane, n-tetradecane, n-pentadecane, n-hexadecane, trichloroethylene, dichloromethane, tetrachloroethylene, trichloromethane, ethyl glycol, 1-methoxy-2-propanol, butyl glycol, butyl glycol acetate, ethylene glycol, propylene glycol, methanol, hydrochloric acid, sulfuric acid and sulfur trioxide, sulfur trioxide, ammonia, dioxins and dioxin-like PCBs (polycyclic chlorobenzenes),
characterized in that the gaseous media is contacted with a filter material comprising Na₂SiO₃, wherein
the filter material comprises Na₂SiO₃ and water, and the water content of the filter material is 8 to 14% by weight, preferably 10 to 14% by weight, more preferably 12 to 13% by weight, based on the total weight of the filter material, and the filter material is obtainable by the following method: water is removed from an aqueous solution of Na₂SiO₃ until the water content value above is reached, the removal of water is performed at a frequency in the range of 2.0 to 3.0 GHz by microwave at a temperature of lower than 200° C.

2. The method according to claim 1, wherein the filter material is obtainable by the following method: water is removed from an aqueous solution of Na₂SiO₃, the removal of water is performed at a frequency in the range of 2.45 GHz by microwave at a temperature of lower than 200° C.

3. The method according to claim 1, wherein the filter material is characterized in that it has characteristic peaks in its Raman spectrum at the following wavenumbers (±5 cm⁻¹): 281 cm⁻¹ and 712 cm⁻¹, preferably at the following wavenumbers (±5 cm⁻¹): 155 cm⁻¹, 281 cm⁻¹ and 712 cm⁻¹; measured with laser having a wavelength of 532 nm.

4. The method according to claim 1, wherein the filter material is characterized in that its thermogravimetric (TG) curve has at least 3 decomposition steps, preferably at the following temperatures (±2° C.): 195° C., 276° C. and 293° C.; measured according to the standard MSZ EN ISO 11358-1:2014.

5. The method according to claim 1, wherein the specific surface area of the filter material is at most 5 m²/g, preferably at most 1 m²/g, more preferably at most 0.5 m²/g and most preferably about 0.25 m²/g.

6. The method according to claim 1, wherein the filter material consists essentially of Na₂SiO₃ and water.

7. The method according to claim 1, for reducing concentration of PAHs.

8. A method for reducing the concentration of the following substances in gaseous media, preferably in air, vapor space and/or flue gases: volatile organic compounds (VOC), semi-volatile organic compounds (SVOC), polyaromatic hydrocarbons (PAH), polychlorinated biphenyls (PCB);
or for reducing the concentration of the following substances: formaldehyde, benzene, toluene, xylenes, ethylbenzene, 1,2,4-trimethylbenzene, 1,2,3-trimethylbenzene, 1,3,5-trimethylbenzene, 2-ethyltoluene, 3-ethyltoluene, 4-ethyltoluene, n-propylbenzene, i-propylbenzene, styrene, cyclohexane, cyclopentane, n-propanol, i-propanol, n-butanol, i-butanol, diacetone alcohol, methyl acetate, ethyl acetate, n-propyl acetate, i-propyl acetate, n-butyl acetate, i-butyl acetate, acetone, methyl ethyl ketone, methyl i-butyl ketone, 2-heptanone, cyclohexanone, methyl tert-butyl ether, tetrahydrofuran, n-pentane, n-hexane, 2-hexane, n-heptane, n-octane, n-nonane, n-undecane, n-dodecane, n-tridecane, n-tetradecane, n-pentadecane, n-hexadecane, trichloroethylene, dichloromethane, tetrachloroethylene, trichloromethane, ethyl glycol, 1-methoxy-2-propanol, butyl glycol, butyl glycol acetate, ethylene glycol, propylene glycol, methanol, hydrochloric acid, sulfuric acid and sulfur trioxide, sulfur trioxide, ammonia, dioxins and dioxin-like PCBs (polycyclic chlorobenzenes),
characterized in that the gaseous media is contacted with a filter material comprising Na₂SiO₃.

9. The method according to claim 8, wherein the filter material comprising Na₂SiO₃ comprises Na₂SiO₃ and water, preferably consists essentially of Na₂SiO₃ and water.

10. A filter material comprising Na₂SiO₃, characterized in that water content of the filter material is 8 to 14% by weight, preferably 10 to 14% by weight, more preferably 12 to 13% by weight, based on the total weight of the filter material, and it is obtainable by the following method:
water is removed from an aqueous solution of Na₂SiO₃ until reaching a water content value of 8 to 14% by weight, preferably 10 to 14% by weight, more preferably 12 to 13% by weight, the removal of water is performed at a frequency in the range of 2.0 to 3.0 GHz by microwave at a temperature of lower than 200° C.

11. The filter material according to claim 10, characterized in that it is obtainable by the following method:
water is removed from an aqueous solution of Na₂SiO₃, the removal of water is performed at a frequency in the range of 2.45 GHz by microwave at a temperature of lower than 200° C.

12. The filter material according to claim 10, characterized in that during the preparation method the removal of water is performed continuously or batchwise, and/or the material is stirred during the removal of water.

13. The filter material according to claim 10, characterized in that it has characteristic peaks in its Raman spectrum at the following wavenumbers (±5 cm⁻¹): 281 cm⁻¹ and 712 cm⁻¹, preferably at the following wavenumbers (±5 cm⁻¹): 155 cm⁻¹, 281 cm⁻¹ and 712 cm⁻¹; measured with laser having a wavelength of 532 nm.

14. The filter material according to claim 10, characterized in that its Raman spectrum, preferably in the range below wavenumber of 120 cm⁻¹, does not comprise peaks having an integral value reaching the half of integral of a peak at wavenumber of 540 cm⁻¹ (+5 cm⁻¹), preferably in the range below wavenumber of 120 cm⁻¹ it does not comprise peaks.

15. The filter material according to claim 10, characterized in that its thermogravimetric (TG) curve has at least 3 decomposition steps, preferably at the following temperatures (+2° C.): 195° C., 276° C. and 293° C.; measured according to the standard MSZ EN ISO 11358-1:2014.

16. The filter material according to claim 10, characterized in that it has at most such a high peak in the range of 100 to 110° C. that corresponds to a weight loss of less than 2%, based on the initial weight of the filter material.

17. The filter material according to claim 10, characterized in that the specific surface area of the filter material is at most 5 m²/g, preferably at most 1 m²/g, more preferably at most 0.5 m²/g and most preferably about 0.25 m²/g.

18. The filter material according to claim 10, which consists essentially of Na₂SiO₃ and water.

19. A filter for filtering out particles harmful to health from a gaseous medium, comprising a filter material (9) arranged in a filter housing (1), characterized in that the filter material (9) comprises sodium silicate, preferably with a particle size in the range of 0.2 to 0.4 mm.

20. Filter according to claim 19, characterized in that powdered sodium silicate is introduced as filter material (9) in the filter housing (1).

21. Filter according to claim 19, characterized in that sodium silicate granules are inserted in the filter housing (1) as filter material (9).

22. Filter according to claim 19, characterized in that the filter material (9) is the filter material as defined in any of points 1 to 18.

23. Filter according to claim 19, characterized in that the filter housing (1) is designed as a housing made of metal, preferably steel, with openings (6) for the flow of the gaseous medium to be filtered.

24. Filter according to claim 23, characterized in that the openings (6) are formed by a metal mesh (5).

25. Filter according to claim 19, characterized in that the filter material (9) is enclosed in a housing of gaseous fluid permeable material, forming a filter insert (8).

26. Filter according to claim 25, characterized in that the housing of the filter insert (8) forms a pre-filter or post-filter layer (11, 12) with respect to the flow direction of the flowing gaseous medium.

27. Filter according to claim 25, characterized in that the filter insert (8) has a shape-retaining frame (7) resulting in a filter cartridge (2).

28. Filter according to claim 19, characterized in that the filter housing (1) itself is designed as a filter frame (2) into which the filter insert (8) can be inserted, stored and removed.

29. The filter according to claim 19, characterized in that a support structure (10) is arranged in the filter insert (8), which ensures an even distribution of the loaded filter material (9).

30. The filter according to claim 29, characterized in that the support structure (10) has a honeycomb design and the support structure (10) together with the loaded filter material (9) is closed by the cover forming the filter insert (8) in such a way as to prevent the filter material from escaping.

31. The filter according to claim 29, characterized in that the support structure (10) is made of stainless steel for use in the vehicle industry.

32. The filter according to claim 19, characterized in that one or more sensors (14) are arranged in the filter cartridge (2).

33. Filter according to claim 32, characterized in that terminals of the sensor (14) are in electrical communication with respective connector surfaces (15) arranged on the filter cartridge (2).

34. The filter according to claim 32, characterized in that the filter cartridge (2) has a lockable door (13) for inserting the one or more sensors (14).
